(19) United States
(12) Patent Application Publication
(10) Pub. No.: US 2007/0266832 A1
(43) Pub. Date: Nov. 22, 2007

(54) Rotary Driving Tool for High Angular Engagement with Elliptiziodal Driving Head

(76) Inventor: Peter Polick, New York, NY (US)

Correspondence Address: BRUCE E. LILLING;LILLING & LILLING PLLC, P.O. BOX 560, GOLDEN BRIDGE, NY, 10526, US

(21) Appl. No.: 11/383,870

(22) Filed: May 17, 2006

(51) Int. Cl. B25B 23/16; B25B 15/00; B25G 1/00; B25B 13/48; B25B 23/00

(52) U.S. Cl. 81/436; 81/177.75

(57) ABSTRACT

This invention relates to the tool and fastener industry, and, more particularly, to a driver designed for coaxial and non-coaxial driving of a head for a threaded connector, such as a screw or bolt with a lobed drive recess. More particularly, to a tool or driver which has an elliptiziodal head to fit a mating lobed recess in the head of a fastener to provide non-binding torque in high angular displacement applications. The head portion conforms to the shape of an elliptiziod whose minor axis lies substantially along the central axis of the tool. The major axis of the elliptiziod is substantially perpendicular to the rotational axis of the tool. The head can be of any diameter and is preferably larger then the shank to avoid necking at the shank head interface.

### BACKGROUND OF THE INVENTION

1. Field of the Invention

This invention relates to the tool and fastener industry, and, more particularly, to a driver designed for coaxial and non-coaxial driving of the head of a threaded connector, such as a screw or bolt with a lobed drive recess. More particularly, to a tool or driver which has an elliptiziodal head to fit a mating lobed recess in the head of a fastener to provide non-binding torque in high angular displacement applications.

2. Description of the Related Art

Traditionally, the threaded fastener industry has been confined to fastener/driver combinations which must be coplanar during operation. Examples include screwdrivers, hex-head wrenches, Torx™, nut drivers and other driver-fastener combinations. Each of these examples are such that the driver must be coplanar with the slot or opening in the fastener head to operate efficiently in manipulating the fastener. For instance, a screwdriver must be coplanar with the slot in the screw head to operate efficiently in manipulating the screw. Likewise, a socket for use in tightening a bolt must be coplanar to engage the polygonal circumference of the bolt for manipulation. Such required alignment can cause problems, such as when a tool cannot be aligned appropriately due to lack of space.

The prior art, in attempting to solve this problem, has approached several limitations. The first limitation as shown in FIG. 1 is the angle with respect to the axis of the fastener in which the tool can be used to turn the fastener without binding the fastener. Some of these devices have been made to have a neck at the drive head. The purpose of the neck is to provide the capability of turning the fastener when the long axis of the drive tool is disposed in an angular relationship with respect to the fastener's axis. This capability is significant where the fastener is located in a hard to reach place.

One such driver is disclosed in Bondhus (U.S. Pat. No. 4,246,811), wherein the device is designed for turning a fastener 112 with a polygonal drive recess. The head of the driver 110 is rounded longitudinally, forming a neck 108, and maintains the flattened faces about its circumference. This shape can be difficult to fabricate and as shown in FIG. 1 does not allow torque to be applied at angles much in excess of 20 degrees due to a detrimental reduction in strength at the neck 108 to accommodate the increased angle. Further, the driver will begin to bind in the recess of the fastener at these increased angles of operation.

One standard type of lobed-recess fastener is that sold by CamCar/Textron under the trademark “TORX” for which there are mate-able lobed drivers. Mikic (U.S. Pat. No. 5,408,905) has attempted to address the issue and to provide non-coaxial driving of a TORX fastener. However, the Mikic device still suffers from minimal gain in offset angle before binding between the recess and the driver occurs.

Croessant (U.S. Pat. No. 1,924,089) describes a pin-ball style extension for socket wrenches having 4 pins offset by 90 degrees around the head of the device. This suffers from binding at extremely small angles due to the pins changing effective angles within the recess during angular operation. Another example of a pin-ball style torque device is given in FIG. 4. This style provides the benefit of increased angle of deflection during use—see FIG. 2. However, the pin will leave the recess in the fastener and reinsert itself during the downward stroke of the arc during high angle operation. FIG. 5 shows the pin structures 100 against the bottom of the recess 102 in the fastener 104 as well as the protrusion of the second pin from the recess during high angle operation.

### BRIEF SUMMARY OF THE INVENTION

The present invention includes a tool with an elliptiziodal head where the minor axis of the head is parallel to the central axis of shank of the tool. The curvature of the elliptiziodal drive head portion is especially designed to permit the maximum amount of tilting of the tool without binding as it is turned, while at the same time allowing for a relatively strong shank on the tool. This is accomplished by providing the head portion with a smooth elliptical surface having no predefined sides. The shank of the tool may take a variety of forms but is preferably in the form of a smooth circular shaft running the length of the axis of revolution, which lies along the central axis of the tool.

The head portion conforms to the shape of an elliptiziod whose minor axis lies substantially along the central axis of the tool. The major axis of the elliptiziod is substantially perpendicular to the rotational axis of the tool. The head can be of any diameter and is preferably larger then the shank to avoid necking at the shank head interface.

Accordingly, it is an object of this invention to provide an improved driver with mating fastener which is efficiently driven without damage to the fastener and driver.

Another object of this invention is to provide an improved driver with mating fastener which permits efficient driving when the driver is misaligned from the fastener axis.

An additional object of this invention to provide an improved driver with mating fastener which will overcome the limitations of the prior art and achieve a greater usable offset angle.

A further object of this invention is to provide an improved driver with mating fastener which is readily engaged in the fastener head and allows for driving without unintended disengagement.

It is also an object of this invention to permit free movement of the driver during use within the fastener at offset angles without binding.

It can also be appreciated that other objects of the invention will become apparent in the detailed description of the invention.

### BRIEF DESCRIPTION OF THE SEVERAL VIEWS OF THE DRAWINGS

FIG. 1 is a perspective view of a hex wrench and the corresponding angle of operation;

FIG. 2 is a perspective view of a ball-pin style wrench and the corresponding angle of operation;

FIG. 3 is a perspective view of an elliptiziodal head wrench in accordance with the present invention and the corresponding angle of operation;

FIG. 4 is a perspective view of a ball-pin style wrench and mating fastener;

FIG. 5 is a partial sectioning of a ball-pin style wrench in the head of a fastener being driven at an angle;

FIG. 6 is a perspective view of the elliptiziodal head wrench in accordance with the present invention and the mating fastener;

FIG. 7 is a perspective view of the elliptiziodal head wrench in accordance with the present invention engaged with the mating fastener;

FIG. 8 is a perspective view of the elliptiziodal head wrench in accordance with the present invention engaged at a first angle with respect to the mating fastener;

FIG. 9 is a perspective view of the elliptiziodal head wrench in accordance with the present invention engaged at a second angle corresponding to 90 degrees from the first angle with respect to the mating fastener;

FIG. 10 is a perspective view of the elliptiziodal head wrench in accordance with the present invention and cut away of the mating fastener in angular alignment;

FIG. 11 is a perspective view of the elliptiziodal head wrench in accordance with the present invention mating with a cut away of the mating fastener in angular alignment;

FIG. 12 is a perspective view 90 degrees separated from FIG. 10 of the elliptiziodal head wrench in accordance with the present invention and cut away of the mating fastener in angular alignment;

FIG. 13 is a perspective view 90 degrees separated from FIG. 11 of the elliptiziodal head wrench in accordance with the present invention mating with a cut away of the mating fastener in angular alignment;

FIG. 14 is a perspective view of the elliptiziodal head wrench in accordance with the present invention and cut away of the mating fastener angularly displaced;

FIG. 15 is a shows the cross section of the elliptiziodal driving head in accordance with the present invention;

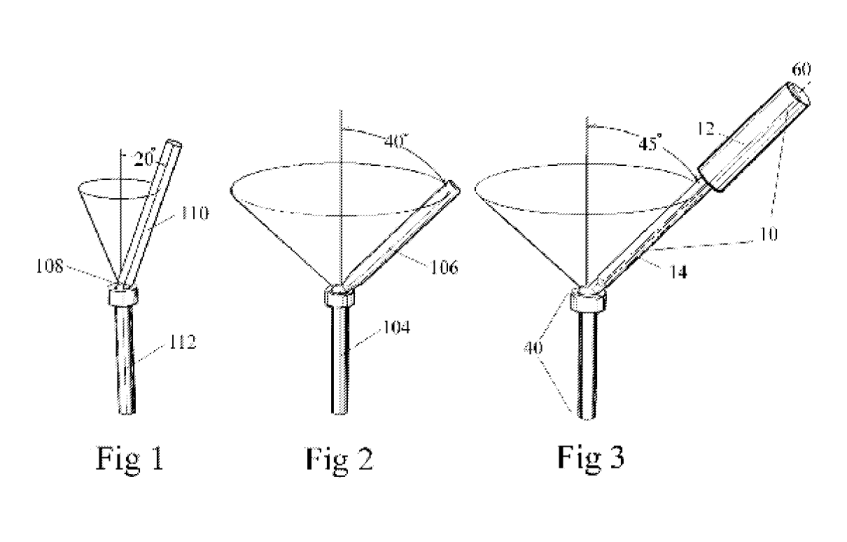

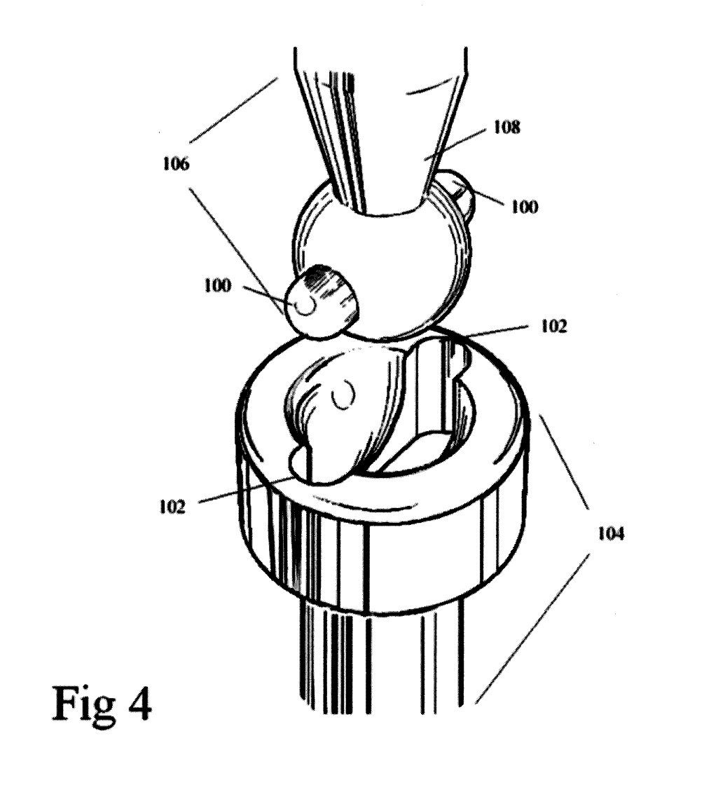

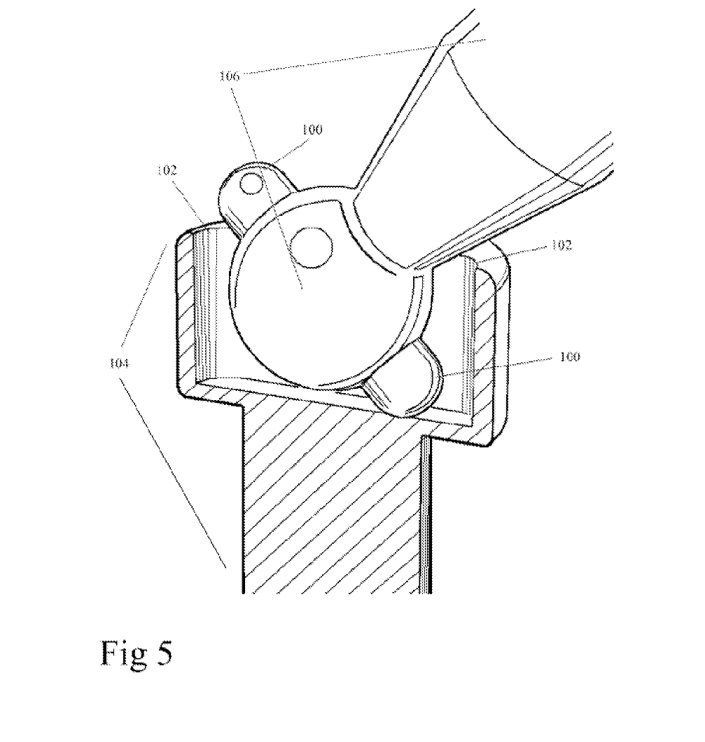

### DETAILED DESCRIPTION OF THE INVENTION

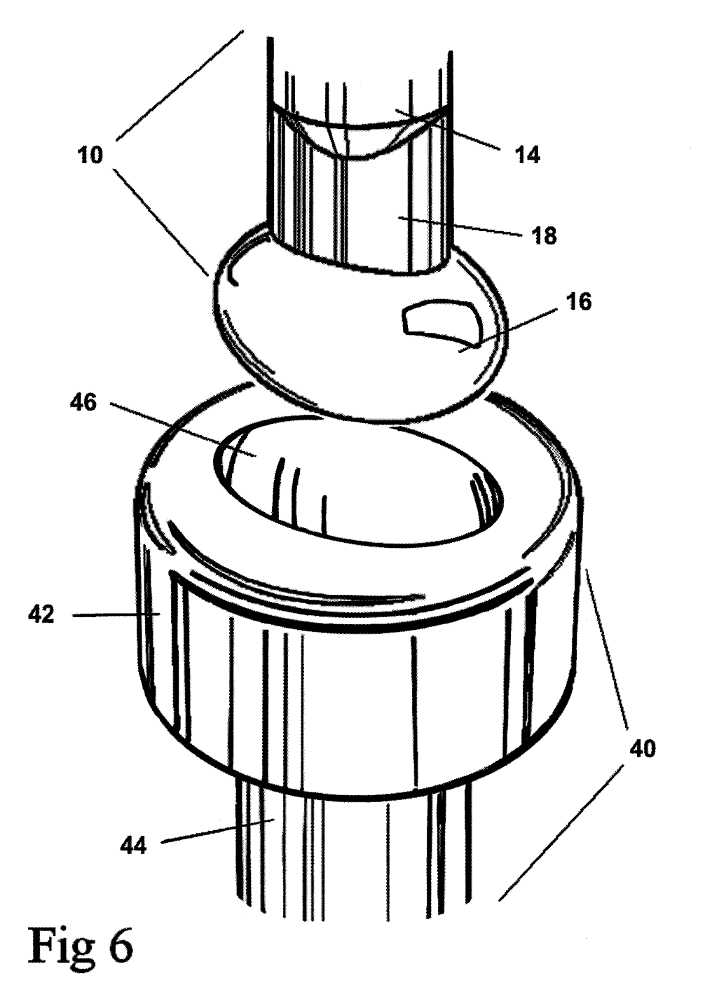

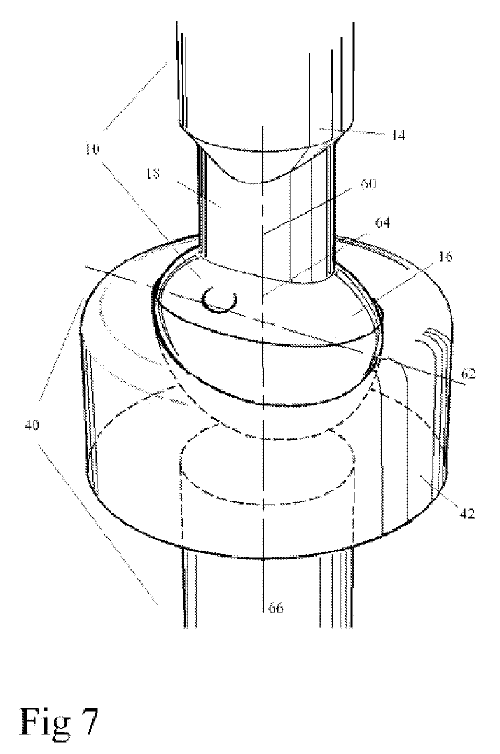

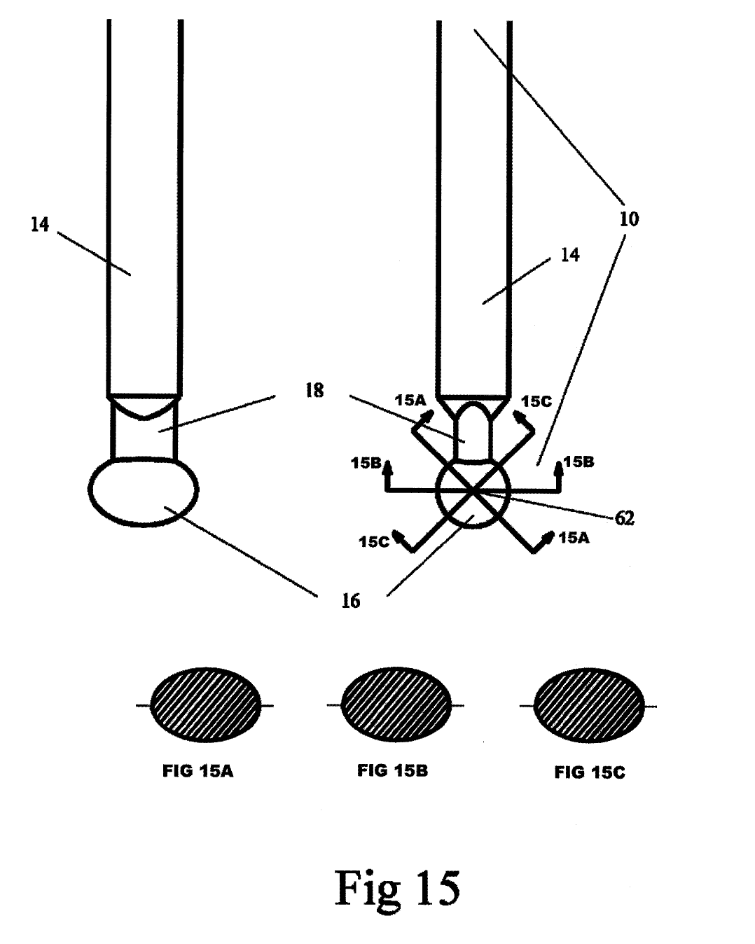

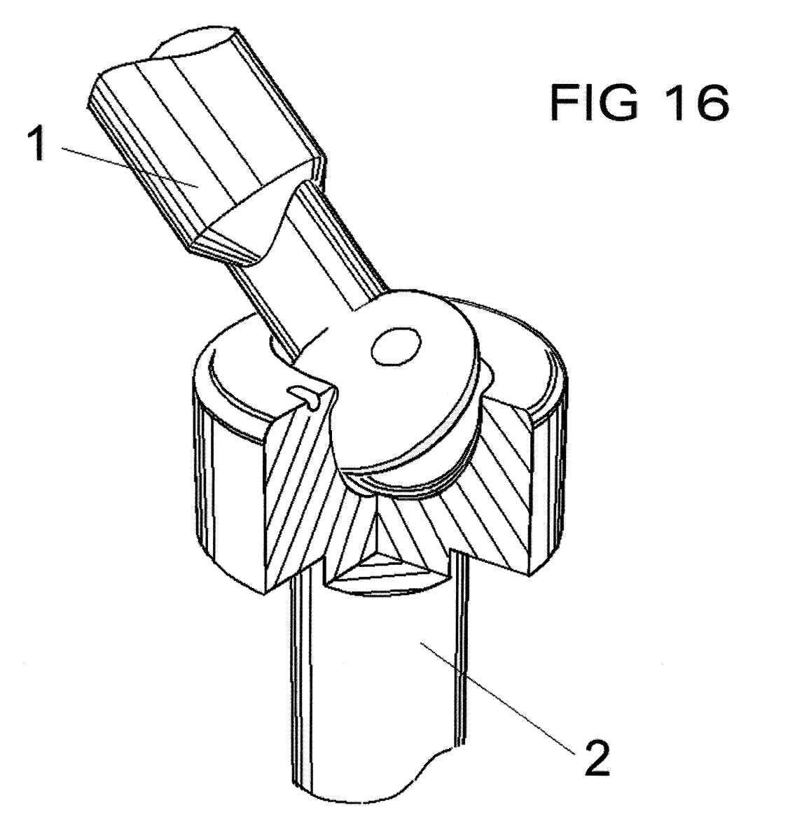

With reference to FIG. 3 the driver 10 in accordance with this invention includes a conventional handle 12 of wood, plastic, metal or the like mounted at one end of an elongated shank 14 typically of hardened steel or the like and having an axis 60. In FIG. 6 the driving head 16 is shown connected integrally or fixedly attached to the extended end of the shaft 14 and may include a neck portion 18. The driving head 16 has a general appearance in elevation or profile of an elongated sphere or an elliptiziod. The driving head 16 thus has a minor axis 64 and a major axis 62 (see FIG. 7). The symmetrical configuration of the driving head 16 is best characterized by cross-section such that at any cross-sectional slice through the major axis 62, which is perpendicular to the axis 60 of shaft 14, an ellipse is created of identical proportion as can be best seen in FIG. 15. The minor axis of the driving head 16 is substantially coaxial to the long axis of the shaft 14 and handle 12 of the driver 10. The surface of the driving head is smooth.

A fastener 40, for mating use with the driving head of this invention, is formed with a conventional threaded shank 44 along axis 66 and may have an enlarged head 42 (see FIG. 6). The head 42 is characterized by an axial socket or recess 46 having an elliptical shape of substantially similar size and shape to that of the elliptiziodal driving head 16, to receive the driving head 16 of the driver 10. The recess 46 is elliptziodal and dimensioned to accommodate the driving head 16 in cooperating driving engagement when the driver 10 is inserted therein as illustrated in FIGS. 7, 11 and 13.

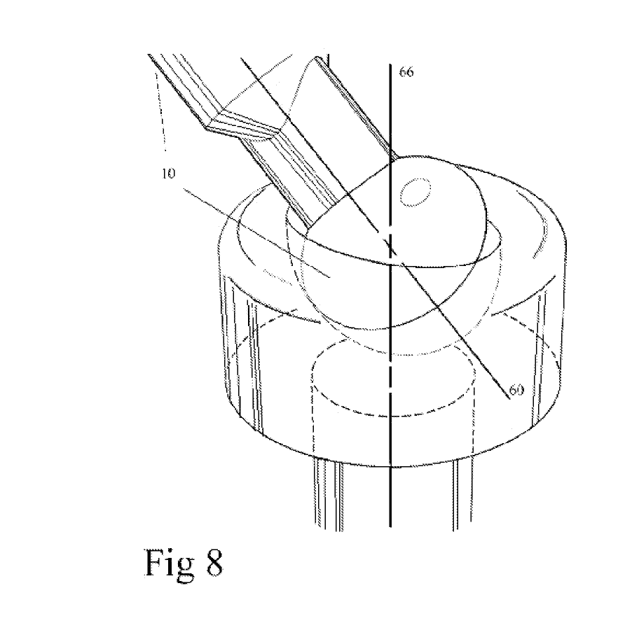

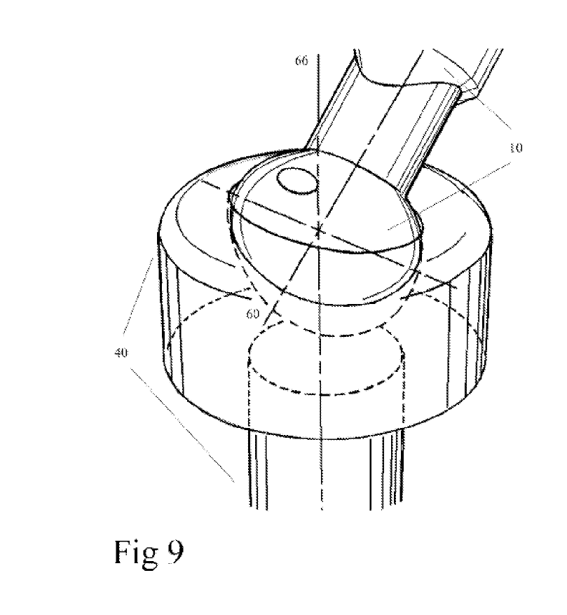

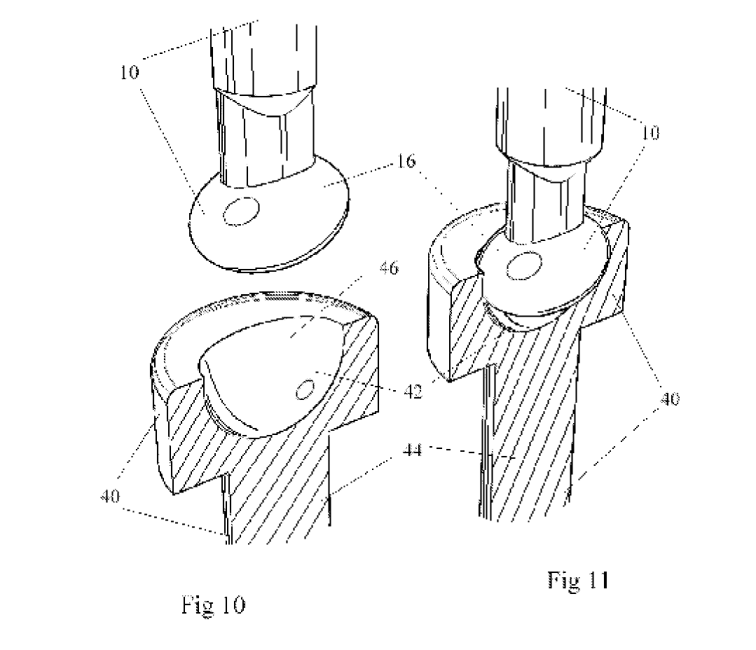

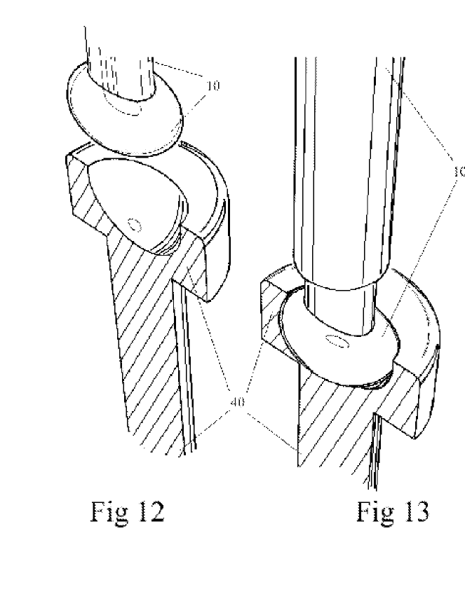

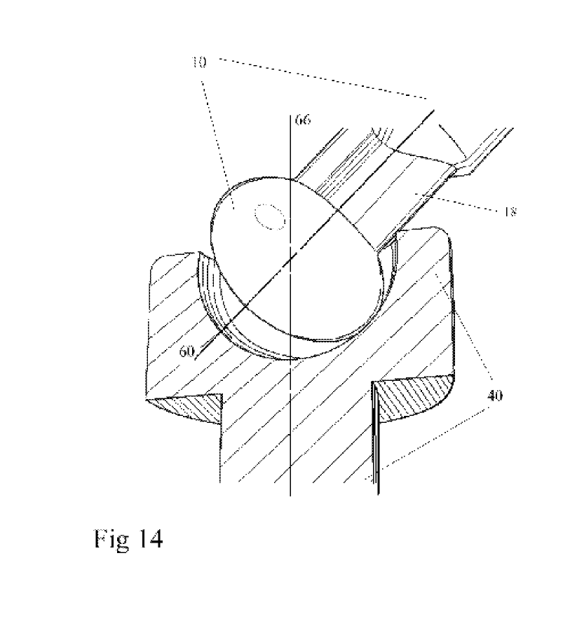

The recess 46 is sufficiently deep so that the driving head 16 may be inserted a distance at least slightly greater then half the minor axis 64 of the driving head 16. It will be appreciated that the geometry of the driving head 16 and the recess 46 is such that the longitudinal axis of either may be angularly oriented with respect to the axis of the other member and still maintain driving engagement. This feature is best shown in FIGS. 8, 9 and 14 where the axis 60 of the driver 10 extends angularly with respect to the axis 66 of the fastener 40. It will be understood that the driver 10 is able to be rotated about its longitudinal axis 60 from this position or from any position within the usable range. Typically, the driver 10 may be operated within a range of 45 degrees or so with respect to the longitudinal axis 66 of the fastener.

Referring now more particularly to FIGS. 7, 8 and 9, it will be seen that when the driving head 16 is inserted in the recess 46 there is very little play between the walls of the recess 46 and the surface of the driving head 16. As best shown in FIGS. 7 and 9 the elliptiziodal shape of the driving head 16 mates with the elliptical cross-section of the recess 46 and the dimensions are such as to provide positive driving engagement with no possibility of the driving head 16 turning within the recess 46. By having a smooth curved surface for the driving head 16, it is possible to rotate the driver 10 about its longitudinal axis 60 with various angles of connection in much the same fashion as a conventional universal joint, but without the usual loose action normally associated with such joints. This feature is particularly advantageous where the fastener must be applied in an awkward or relatively inaccessible location. For example, it is well known that it is difficult to drive in a screw that is immediately adjacent one wall or in a corner. Now, however, by employing a fastener and driver of the type illustrated herein, complete and forceful driving action may be applied to the fastener from any number of convenient angles. This permits the fastener to be driven in locations which heretofore would have been difficult or impossible to attain with the conventional tools. Obviously, the driver will function in a perfectly efficient manner when aligned axially with the fastener as well as when angularly offset there from.

While the invention has been described herein with particular reference to the illustrated embodiment, it will be understood that numerous modifications thereto will appear to those skilled in the art without departing from the invention. For example, the coupling arrangement may be employed in various other situations normally employing a universal joint. It will be appreciated that the coupling provided by this invention may be produced at a much lower cost than the conventional universal couplings which require a number of different parts hinged for angular movement with respect to one another. Further, the driving head may be connected to a power drive for use in assembly line operations or the like and need not necessarily have a handle. For further convenience, the shank and head of the screwdriver may be permanently magnetized so that magnetically attractive screws may be preassembled over the head for reaching to remote locations. Accordingly, the above description and accompanying drawings should be taken as illustrative of the invention and not in a limiting sense.

1. A driver for transmitting torque comprising:
a drive shank portion having an elongated longitudinal central axis; and
a drive head portion fixedly attached or integral to an end of said shank portion and having a cross sectional configuration of an ellipsoid, whereby a solid elliptiziod is defined and has a minor axis coaxial with said longitudinal central axis of said shank portion.

2. The driver for transmitting torque of claim 1 where a handle is fixedly attached or made integral to an opposite end of said shank portion.

3. The driver for transmitting torque of claim 1 where said shank portion is of elliptical cross-section.

4. The driver for transmitting torque of claim 1 where said shank portion is of circular cross-section.

5. The driver for transmitting torque of claim 1 in combination with a fastener in which is formed an axial recess.

6. The driver for transmitting torque of claim 5 wherein said driver head portion being dimensioned for mating insertion and driving engagement with said axial recess in said fastener.

7. The driver for transmitting torque of claim 6 wherein said central axis of said shank of said driver for transmitting torque operates at angles up to 45 degrees from coaxial alignment with a central axis of said fastener.

8. The driver for transmitting torque of claim 1 in combination with a second torque transmitting device in which is formed an axial recess dimensioned for mating insertion and driving engagement of said drive head portion to form a universal joint.

9. A driver for use with a fastener in which is formed an axial recess, the combination comprising:
a driver having a driver head portion, and a shank portion;
said shank portion having an elongated longitudinal central axis; and
said driver head portion having a cross sectional configuration of an ellipsoid, whereby a solid elliptiziod is defined and has a minor axis coaxial with said longitudinal central axis of said shank portion;
said driver head portion being dimensioned for mating insertion and driving engagement with said axial recess in said fastener;
wherein said central axis of said shank of said driver for transmitting torque operates at angles up to 45 degrees from coaxial alignment with a central axis of said fastener.

10. The driver for transmitting torque of claim 9 where a handle is fixedly attached or made integral to said second end of said shank portion.

11. The driver for transmitting torque of claim 9 where said shank portion is of elliptical cross-section.

12. The driver for transmitting torque of claim 9 where said shank portion is of circular cross-section.

13. a fastening system comprising a driving portion and a fastener portion wherein;
said driving portion comprises;
a driver head portion, and a shank portion;
said shank portion having an elongated longitudinal central axis; and
said driver head portion having a cross sectional configuration of an ellipsoid, whereby a solid elliptiziod is defined and has a minor axis coaxial with said longitudinal central axis of said shank portion;
said fastener portion having and end with and axial recess and said driver head portion being dimensioned for mating insertion and driving engagement with said axial recess in said fastener;
wherein said central axis of said shank of said driver for transmitting torque operates at angles up to 45 degrees from coaxial alignment with a central axis of said fastener.

14. The driver for transmitting torque of claim 9 where a handle is fixedly attached or made integral to said second end of said shank portion.

15. The driver for transmitting torque of claim 9 where said shank portion is of elliptical cross-section.

16. The driver for transmitting torque of claim 9 where said shank portion is of circular cross-section.
